(19) United States
(12) Patent Application Publication
(10) Pub. No.: US 2010/0284245 A1
(43) Pub. Date: Nov. 11, 2010

(54) APPARATUS FOR AND METHODS OF MIXING AND DISPENSING LIQUID OR POWDERY SAMPLES

(75) Inventors: Alan McNicol, North Yorkshire (GB); Simon Gibson, Northallerton (GB); John Carroll, Stockton on Tees (GB)

Correspondence Address: Jones Day, 222 East 41st Street, New York, NY, 10017, US

(73) Assignee: Brunob II B.V., Arnhem (NL)

(21) Appl. No.: 12/449,576

(22) PCT Filed: Feb. 14, 2008
(86) PCT No.: PCT/GB2008/000512

§ 371 Date: Aug. 14, 2009

(30) Foreign Application Priority Data
Feb. 16, 2007 (GB) 0703053.9

(51) Int. Cl. B01F 7/24; B01F 7/00; B01F 7/16

(52) U.S. Cl. 366/293

(57) ABSTRACT

Apparatus and methods of mixing and dispensing small samples are described. Samples may be mixed in a small vessel (12) which is provided with an impeller (20) located at or adjacent its base (14) and driven by a shaft (22) extending through the base. Mounted for rotation within the vessel, either with the impeller or independently thereof, is an agitator means such as a helical spring (28) which is compressible towards the impeller under applied load. Samples may be dispensed from the vessel using a piston member (40) having a through passage (44). The piston member is insertable into the vessel to force the sample therefrom through the passage.

The invention relates to apparatus for and methods of mixing and dispensing samples for use in the preparation and analysis of materials and, in particular, for the characterisation of existing materials and the identification of new materials.

The characterisation of materials with a view to improving or optimising formulations or to identifying new and useful compositions usually requires the performance and recordal of large numbers of experiments. The preparation of samples for such experiments is time consuming and prone through poor human performance (owing to fatigue, boredom etc in performing repetitive operations) to error in measurement of quantities of ingredients and/or recordal of volumes, weights and other details relating thereto. The nature of the ingredients themselves, for example low viscosity liquids, medium and high viscosity liquids, thixotropic liquids, powders etc, owing to the difficulty in accurately dispensing them, may compound such human-generated errors or give rise to other potential errors during the dispensation of such ingredients.

Additional problems may arise in accurately dispensing small quantities of ingredients when seeking to scale down the size of the experimental samples in dispensing small quantities of minor ingredients. Many formulations typically have minor ingredients which, on scaling down the sample size, become very small quantities indeed. For example, an ingredient present at 0.1% weight in a formulation is 200 mg on a 200 g sample size, but becomes 10 mg on a 10 g sample size.

Although these problems may be overcome by using suitable apparatus and methods for automatically dispensing liquids and powders, in many instances the adequate mixing of ingredients, especially in small amounts, may be difficult to achieve thus leading to non-homogeneous mixtures or reaction products. Additionally, the subsequent delivery of such mixtures or reaction products from a mixing environment to a subsequent environment for (further) reaction or testing may also be problematical, especially when the mixtures or reaction products have a high viscosity.

As explained in US 2003/0169638 A, various techniques have been used to mix small quantities of reactants for parallel reaction procedures; for example high-speed shaft-driven rotational stirrers, magnetic flea stirring bars, orbital shakers and vibratory devices have been proposed. US 2003/0169638 A itself proposes a shaft-driven rotational stirrer to be located in the reaction vessel from the top thereof,

wherein the impeller has a particular design and set of dimensions. The use of such an impeller is said to effect efficient mixing of reaction ingredients in the reaction vessel. However, it is apparent that, if the reaction mixture is relatively viscous and there is a requirement to remove it from the vessel for further processing such as additional reactions or testing, much of the material is likely to cling to the impeller and will be lost as the impeller is removed from the vessel or will have to be cleaned from the impeller creating additional processing problems. For small samples, the potential loss of significant quantities thereof on the impeller may be very detrimental to the subsequent processing of the samples.

Another approach for removing material from a dispensing reservoir has been proposed in US 2005/0283113 A (equivalent to GB 2415423 A) wherein a sample is located within a dispensing vessel which is then fitted with a piston having a through bore such that the assembly functions as a syringe to dispense material. US 2005/0283113 A also describes mixing ingredients in the reservoir, for example by using a magnetic stirrer or glass balls; however, no mention is made of how the presence of such items affects the recovery of material or amount of material that may be recovered from the vessel.

Examples of syringe-like mechanisms for dispensing materials are also described in GB 696310, GB1178738, GB1441983, U.S. Pat. No. 4,741,737, U.S. Pat. No. 4,805,810 and DE 19915771.

It is an object of this invention to provide apparatus and methods for mixing small volumes of materials to produce substantially homogenous samples which, if desired, can then be dispensed.

According to the present invention, apparatus for mixing small samples of materials comprises a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel.

Also, according to the present invention, a method of mixing small samples of materials comprises providing a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, introducing at least two components into said vessel, operating said impeller and agitator means for a period sufficient to effect mixing of said components into a substantially homogeneous sample.

The invention also includes apparatus for mixing and dispensing small samples of materials comprises a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, said material removal means comprising a piston member adapted to fit in sealed relationship with the peripheral wall of said vessel, said piston member having an axially-extending through passage which, in use, communicates at one end with the interior of said vessel and forms a dispense opening at the other end whereby axial movement of said piston member within said vessel to apply pressure to a sample formed therein will cause said sample to flow through said passage.

The invention also includes a method of mixing and dispensing small samples of materials comprises providing a vessel for containing components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, introducing at least two components into said vessel, operating said impeller and agitator means for a period sufficient to effect mixing of said components into a substantially homogeneous sample, placing said material removal means comprising a piston member adapted to fit in sealed relationship with the peripheral wall of said vessel into the top of said vessel, said piston member having an axially-extending through passage communicating at one end with the interior of said vessel and forming a dispense opening at the other end, moving said piston member axially within said vessel to apply pressure to said sample to cause said sample to flow through said passage.

Typically, the vessel is generally cylindrical in shape, although, if desired, it may be non-circular in cross-section. Preferably the base of the vessel is flat to avoid potential dead spaces in which material may reside and not be mixed. The vessel preferably has an overall capacity of not more than about 100 ml, more preferably not more than about 20 ml. Preferably, the height to internal diameter ratio is not more than about 10 and preferably is not less than about 0.5. More typically, the height to internal diameter ratio is about 4.

The sample capacity of the vessel, ie the volume occupied by the sample components and the sample once mixed, may be in the range 20 to 95% of the volume of the vessel. Preferably, the sample capacity of the vessel is more typically in the range 20% to 60% of the volume of the vessel. Preferably, depending on the size of vessel used, the sample capacity of the vessel is not more than about 50 ml, more preferably not more than about 25 ml and is typically in the range 5 ml to 15 ml.

Preferably, the bottom of the impeller is spaced axially a small distance from the bottom of the vessel, typically about 1 to 5 mm. Preferably, the impeller has at least one blade, more particularly at least two or more blades. The blades of the impeller are each preferably set at an angle to planes containing the axis of rotation of the impeller whereby axial movement of material through the impeller may be achieved on rotation of the impeller. The impeller preferably has a diameter in the range 60% to 95% of the internal diameter of the vessel, more particularly in the range 80% to 95% of said internal diameter, and especially in the range 90% to 95% of said internal diameter. Preferably, the impeller has an axial extent not more than 10%, more particularly not more than 5%, of the height of the vessel.

The angle of the blades in combination with the direction of rotation of the impeller is preferably such that the sample components are moved axially towards the base of the vessel whereby, under the force of such movement, the materials are forced towards said base and are forced radially outwardly therefrom to circulate axially past the radial periphery of the impeller and back to a location in said vessel that is above the impeller.

The impeller is integral with the end of the shaft or is mounted on the end of the shaft by any suitable mechanical means, such as interference fit, screw threads, retaining screws or nuts etc. The shaft extends through the base of the vessel in sealed, rotational relationship therewith. The sealed, rotational relationship between the base of the vessel and the shaft may be attained by any convenient mechanical arrangement.

In a preferred, embodiment, the base of the vessel is provided with a cylindrical extension in which a seal and bearing arrangement for supporting the shaft in said sealed, rotational relationship therewith is mounted.

The agitator means of the present invention may take a variety of forms.

In one embodiment, the agitator means may comprise vanes, whether in the plane of the axis or at an angle thereto, fixed to the wall of the vessel (or a sleeve lining the vessel). In this embodiment, the vessel (or the sleeve) is adapted for rotation relative to the impeller to impart shear forces to components of the material being mixed in the vessel. Also in this embodiment, the piston member has complementary grooves for the vanes and, if the vanes are angled to the axis, is mounted for rotation in a support sleeve.

In another embodiment, the agitator means may comprise vanes mounted on an axially-extending support located generally coaxially of the vessel, the piston being complementary configured as described in the preceding paragraph.

In yet a further embodiment, the vanes are provided with weakened roots and shear off under the load applied by the piston.

In a preferred embodiment of the invention, the agitator means is mounted in the vessel and is reciprocally moveable between an operable position wherein the member may agitate material within the vessel and an inoperable position in which it is compressed and positioned immediately adjacent the impeller.

In this embodiment, the agitator means may comprise shaped memory material wherein its default shape is in the operable position. In this instance, the agitator means may be moved to an inoperable position either by an axially-located rod attached to its end remote from the impeller and reciprocally-moveable relative to the vessel or by being moveable under force applied by the piston member.

In an alternative form, the agitator means may be inflated/deflated by the application of fluid under pressure/vacuum between said positions.

In a particularly preferred embodiment of the invention, the agitator means comprises a helical member mounted within the vessel. In an even more preferred embodiment, the helical member is a substantially cylindrical helical member. Alternatively, the helical member is a substantially conical helical member, the apex of the cone either being mounted adjacent the impeller or being remote from the impeller.

Preferably, the helical member comprises a substantially cylindrical helical spring.

The helical member is preferably circular in cross-section; alternatively, the helical member may have a flattened cross-section, for example elliptical or ribbon-like, to present a higher surface area for contacting sample components within the vessel.

In one embodiment, the helical member may be mounted on the impeller for rotation therewith. In an alternative embodiment, the helical member may be mounted on a separate shaft, for example concentric with the impeller shaft. In this embodiment, the helical member may be rotated both in the same direction as the impeller or in the opposite direction to the impeller or may be alternatively rotated in the same direction and then the opposite direction. Rotation of the helical member within the vessel applies shear forces to sample components therein and tends to move the components axially of the vessel to aid mixing of the components. Depending upon the handedness, or chirality, of the helix of the member and the direction of rotation of it, sample components may be moved axially either towards or away from the impeller.

In an alternative embodiment, the agitator means may comprise more than one helical member, which may, for example, be opposite handed and arranged to counter-rotate with respect to one another.

Preferably, the helical member extends axially above the impeller by at least 10% of the height of the vessel. More preferably, the helical member extends axially above the impeller by at least 30%, more especially at least 50%, of the height of the vessel. The helical member may extend axially above the impeller up to 90% of the height of the vessel.

The pitch of the helical member is sufficient to permit the member to be moved towards the impeller under applied force. Preferably, the pitch permits the helical member to be reduced to not more than 20%, preferably not more than 10%, and in particular not more than 5%, of its normal length.

The helical may be moved to an inoperable position either by an axially-located rod attached to its end remote from the impeller and reciprocally-moveable relative to the vessel or by being moveable under force applied by the piston member.

The shaft or shafts for the impeller and agitator means may be rotationally-driven by any suitable drive mechanism. For example, an electric motor may be used to drive the shaft or shafts directly, if necessary through gearing.

In a preferred embodiment, the drive to the shaft or shafts is via a quick-release coupling mechanism such as complementary male and female parts which positively engage with one another.

Drive may be delivered to the impeller and, if separately driven, to the agitator means so that they rotate in one direction only; alternatively, the drive delivered to the impeller and, if separately driven, to the agitator means may be reversible. The drive may be deliverable to the impeller and, if separately driven, to the agitator means in pulses, which again may be reversibly applied.

Preferably, the vessel is adapted to be secured against rotation during operation of the impeller thereby to avoid rotation of the vessel.

Preferably, said piston member comprises an elongate body having an axially-extending through passage, preferably located centrally thereof, which, in use, communicates at one end with the interior of said vessel and forms a dispense opening at the other end. The piston member is adapted to fit in sealed relationship with the peripheral wall of the vessel. To achieve the sealed relationship, the piston member may be a close sliding fit within the peripheral wall of the vessel. If required, resilient sealing rings may be provided on the piston member. The end of the piston member locatable in the vessel is preferably flat and, upon axial movement of the piston member into the vessel, is engageable with the agitator means to move it axially towards the impeller. The dispense opening is preferably formed in short stub extending from the other end of the piston member. Alternatively, the dispense opening may communicate with a dispense nozzle fitted to the piston member.

Both the vessel and the piston member are adapted to be gripped by gripping mechanisms on mixing and/or dispensing equipment and may be provided with appropriate gripping and/or bearing surfaces by which they may be gripped and/or have force applied thereto to enable dispensing of a sample therefrom.

The vessel, impeller, agitator means, drive shaft(s) and piston member may be made from any suitable material depending upon the sample components and the samples, proposed operating conditions, eg temperature etc, and whether recycling or disposal of the vessel etc is required. For more chemically-aggressive sample components and samples, the apparatus components may be made from chemically-resistant steels or other metals or alloys or from chemically-resistant plastic materials such as aromatic polymeric materials, for example aromatic polyethers such as polyaryl ether ether ketone (PEEK). When the chemical environment is less aggressive materials such as aluminium may be used for the apparatus components. In relatively benign environments, such as when investigating food components, for example flavouring compounds, starches, hydrocolloids and the like, it is possible to use plastic materials such as polypropylene and polyethylene.

Additionally, mixtures of materials may be used, for example, it may be preferred for the agitator means in the form of a helical spring to be made of spring steel or other suitably resilient material irrespective of the material selected for other apparatus components.

It is within the scope of the present invention to further react the samples of materials within the vessels in which they are prepared rather than to dispense them from such vessels.

In preferred forms of the present invention, the apparatus and methods of the present invention comprise arrays of vessels whereby multiple samples may be prepared in parallel. The samples may be the same to provide statistical information on repeatability of samples; or may differ in terms of concentrations, numbers of components etc. When the samples are different, it may be preferred still to have multiple samples which are the same to ensure mean values are obtained. For example, in an array of twenty four vessels, six different sets of four samples may be prepared.

In such arrays, the drive to the shaft or shafts for the impeller and agitator means may be individual drives to each shaft or, alternatively, may be a common drive linked to the shafts through suitable gear trains or similar transmission mechanisms.

Furthermore, the samples prepared in such arrays may be further reacted in parallel; or may be dispensed either individually or in parallel.

As will be appreciated when arrays of vessels are provided and multiple samples prepared, the vessels will have associated automated handling equipment including robotic arms/grippers, computer control and recordal of results, etc.

Whilst the apparatus and methods of the invention may be utilised to prepare and dispense a wide variety of samples at widely differing viscosities, the invention has particular utility in preparing samples of relatively viscous materials, for example gums, resins, polymer mixtures, food ingredients such as butter, peanut butter, doughs etc, adhesives, paints, flavouring ingredients, personal care formulations, lubricant formulations, multi-component and/or multi-phase systems, filled compositions.

The invention will now be illustrated by reference to the accompanying drawings, in which:

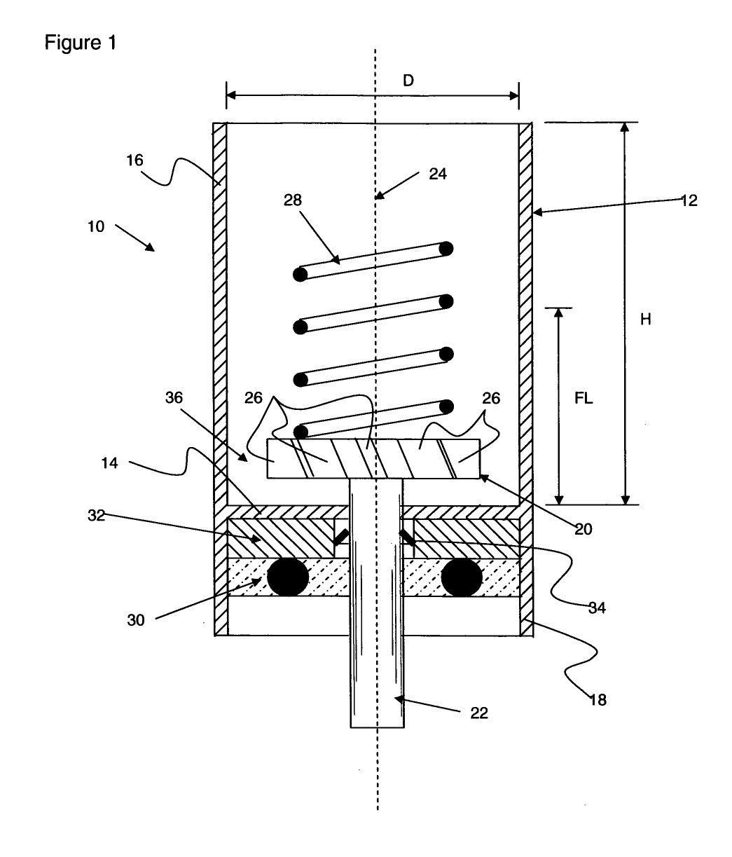

FIG. 1 is a schematic vertical cross-section of mixing apparatus according to the invention;

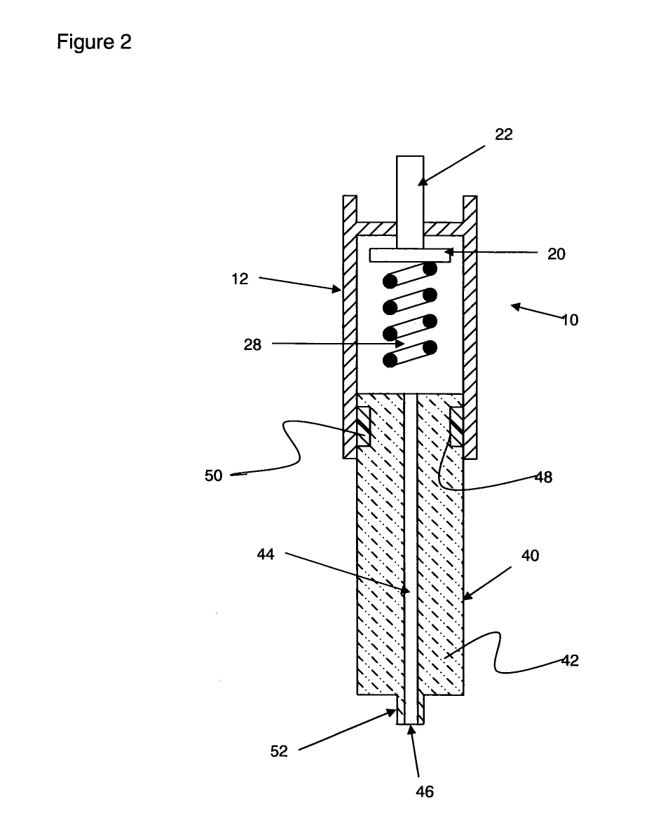

FIG. 2 is a simplified schematic vertical cross-section of the mixing apparatus as shown in FIG. 1 but as used in a dispensing mode; and

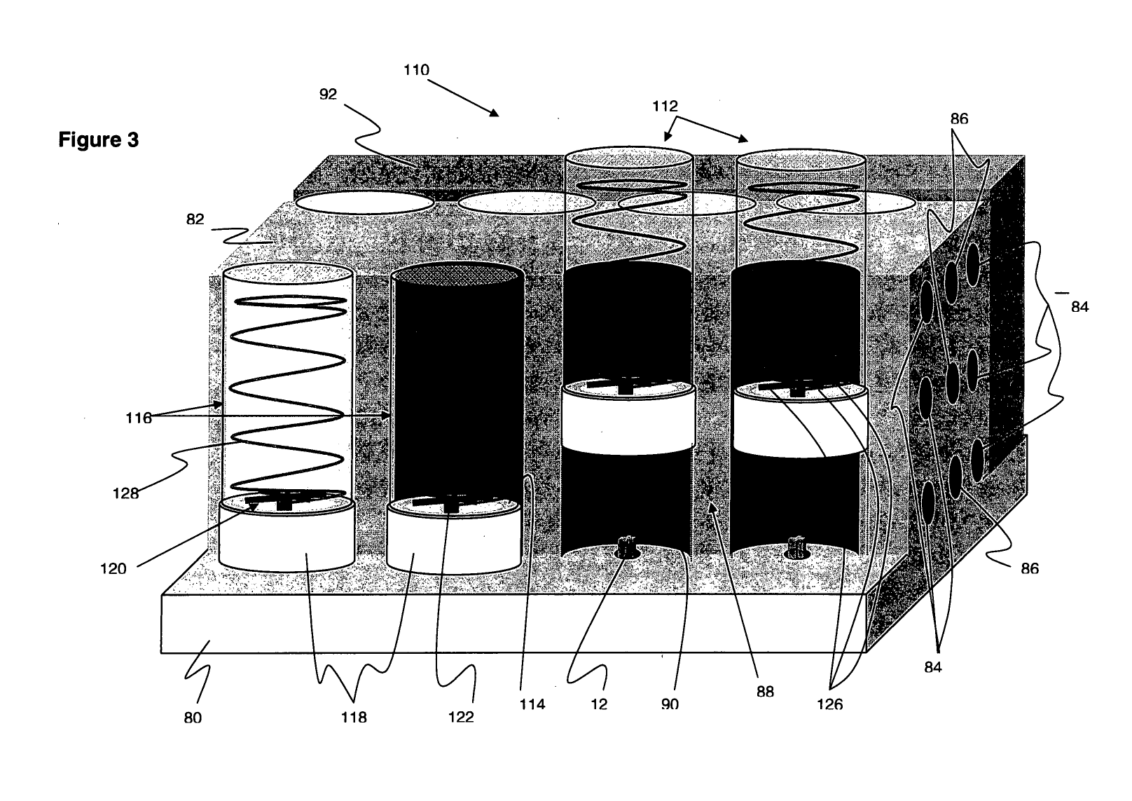

FIG. 3 is a schematic perspective view of mixing apparatus according to the invention, which apparatus comprises an array of vessels.

Referring to FIG. 1, mixing apparatus 10 in accordance with the present invention comprises a vessel 12 having a flat base 14, a cylindrical peripheral wall 16 extending from the base 14 upwardly to define an open top through which sample components (not shown) may be introduced into the vessel 12. The base 14 of the vessel 12 is provided with a lower cylindrical extension 18. The vessel 12 is useful for mixing small amounts of materials having a combined volume preferably less than about 50 ml, more preferably less than about 20 ml, and most preferably no more than about 10 ml. The materials being mixed can be liquids or combinations of liquids and solids. If an appropriate cannula (not shown) is provided in sealed relationship with the vessel 12, it may also be possible to introduce gases into the sample mix.

The vessel 12 has an overall height H and an inside diameter D. The vessel 12 is filled typically with liquid and/or solid components to be mixed up to a fill level FL, which is typically 20 to 95% of the volume of the vessel 12. Preferably, the sample capacity of the vessel is more typically in the range 20% to 60% of the volume of the vessel 12 and preferably about 30% to 50%, but which may vary considerably, depending on the particular reaction. For small-volume mixing, the vessel 12 should have an overall capacity of less than about 100 ml, and preferably no more than about 50 ml. The vessel 12 should further have a height to inside diameter ratio (H/D) as previously described and is preferably about 2 to 6. Typical dimensions for the vessel are H=95 mm and D=23 mm.

The vessel 12 is provided with an impeller 20 mounted on a shaft 22 for rotation about the longitudinal axis 24 of the vessel 12. The impeller 20 is located 4 mm above the base 14 of the vessel 12 and has several blades 26 each at an angle to a plane containing the axis 24. The axial extent of the impeller 20 is typically 8 mm (9% of H).

Mounted on the top side of the impeller 20 for rotation therewith is an agitator means in the form of a cylindrical helical spring 28. The spring 28 has a pitch of 5 mm whereby force applied to it along the axis 24 will compress the spring 28 to substantially cause adjacent turns of it to contact one another. The compressed height of the spring is preferably no more than 10 mm (or 12% of H).

The shaft 22 extends through an aperture in the base 14 of the vessel 12 and is a close fit therein. The shaft 22 is supported coaxially with the axis 24 by a bearing 30 located within the extension 18 of the vessel 12. An annular sealing ring 32, carrying an annular resilient seal 34 within its inner periphery, is located within the extension 18 between the bearing 30 and the base 14 of the vessel 12. The seal 34 contacts the shaft 22.

The shaft 22 external to the vessel 12 may be coupled to a drive mechanism (not shown). The drive mechanism may be any suitable mechanism and typically is an electric motor connected to the shaft 22 through suitable gearing.

A sample may be mixed in the apparatus 10 by introducing sample components, for example liquids or liquids and solids, either manually or using any convenient automated dispensing equipment, into the vessel 12 through the open top thereof. If required, a cap (not shown) may be used to seal the open top of the vessel 12. The drive mechanism for the impeller 20 is then operated to rotate it at high speed, typically in the range 500 rpm to 4000 rpm, to mix the components to form the sample. The angle of the blades 26 of the impeller 20 to planes containing the axis 24 and the direction of rotation of the impeller 20 combine during the mixing operation to force material towards the base 14 of the vessel 12 and then radially-outwardly and axially upwardly through the annular gap 36 between the impeller 20 and the peripheral wall 16 of the vessel 12.

The spring 28 rotates with the impeller 20 and its handiness is such that material in the vessel 12 will be forced axially towards the impeller 20.

If in any particular instance it is found to aid mixing, the direction of rotation of the impeller, and of the spring 28, may be reversed or may be delivered in pulses, either in the same direction or in reverse.

The drive to the impeller is for a period sufficient to produce a substantially homogeneous mixture of the components to form the sample, which may be simple mixing of the components or it may also involve physical or chemical reactions.

Referring to FIG. 2, once the sample has been mixed, the cap, if present, is removed from the top of the vessel 12 and a piston member 40, which is a close sliding fit in the vessel 12, is inserted therein. The piston member 40 comprises an elongate body 42 having an axially-extending, central through passage 44, which, in use, communicates at one end with the interior of the vessel 12 and forms a dispense opening 46 at the other end. The end of the piston member 40 locatable in the vessel 12 is preferably flat and, upon axial movement of the piston member 40 into the vessel 12, is engageable with the spring 28 to move it axially towards the impeller 20. Near the end of the piston member 40 locatable in the vessel 12, the body 42 is provided with an annular recess 48 in which is positioned a low friction resilient sealing ring 50, for example a silicon rubber sealing ring. The dispense opening 46 is formed in short annular stub 52 extending axially from the body 42 of the piston member 40.

The assembly of the vessel 12 and the piston member 40 is then inverted and, either manually or in an automated dispensing apparatus, pressure is applied to cause relative movement of the vessel 12 and the piston member 40 with respect to one another whereby the piston moves into the vessel 12 to force the sample out through the passage 44 to exit through the dispense opening 46. In moving into the vessel 12 the flat end of the piston member 40 engages the spring 28 to force it towards the impeller 20 so that it does not interfere with or prevent flow of the sample from the vessel 12, whereby removal of the sample from the vessel 12 is maximised.

Referring to FIG. 3, mixing apparatus 110 in accordance with the present invention comprises an array of vessels 112, which are essentially the same as the vessel 12 shown in FIGS. 1 and 2.

The apparatus 110 has a support plate 80 on which is mounted a heating/cooling block 82 through which extends heating elements 84 and cooling elements 86. Lateral surfaces 88 of the block 82 are provided with part-cylindrical recesses 90 to match the walls 116 (see below) of the vessels 112. The vessels 112 are held in place in the recesses 90 by a pair of clamping plates 92 (only the rear one shown). The clamping plates 92 are pneumatically-operable to move them into clamping relationship with the vessels 112 located adjacent the recesses 90 and are retractable by springs (not shown). The faces of the clamping plates 92 that contact the vessels 112 may be flat as shown or, alternatively, may have complementary part-cylindrical recesses to the recesses 90.

In FIG. 3, two of the vessels 112 are shown partially removed from their clamped positions to enable a detail of the drive (described below) to be illustrated.

Each vessel 112 has a flat base 114 and a cylindrical peripheral wall 116 (both of which are shown as transparent in the schematic drawing to enable the interior features to be displayed) extending from the base 114 upwardly to define an open top through which sample components (not shown) may be introduced into the vessel 112. The base 114 of each vessel 112 is provided with a lower cylindrical extension 118. The dimensions of the vessels 112, including H to D ratios and fill levels are similar to those of the vessel 12 shown in FIGS. 1 and 2.

Each vessel 112 is provided with an impeller 120 mounted on a shaft 122 for rotation about the longitudinal axes of the vessel 112. Each impeller 120 is located 4 mm above the base 114 of the vessel 112 and has several blades 126 each at an angle to a plane containing the axis of the vessel 112. The axial extent of each impeller 120 is typically 8 mm (9% of H).

Mounted on the top side of each impeller 120 for rotation therewith is an agitator means in the form of a cylindrical helical spring 128. Each spring 128 has a pitch of 5 mm whereby force applied to it along the axis of the vessel 112 will compress the spring 128 to substantially cause adjacent turns of it to contact one another. The compressed height of the spring is preferably no more than 10 mm (or 12% of H).

Each shaft 122 extends through an aperture in the base 114 of its respective vessel 112 and is a close fit therein. Each shaft 122 is supported coaxially with the axis of its respective vessel 112 by a bearing (not shown) located within the extension 118 of the vessel 112. The bearing and seal arrangements for the shafts 122 are essentially as shown in FIG. 1.

Each shaft 122 has a lower shaped recess (not shown) to receive a male drive shaft 123 passing through and mounted by a bearing in the support plate 80. The shaft 123 is coupled to a drive mechanism (not shown).

The drive mechanism may be any suitable mechanism and typically is an electric motor. In one embodiment, a single motor may be connected to each of the shafts 123 through suitable gearing. In a preferred embodiment, each shaft 123 is individually driven whereby differences in torque generated within the different samples may be monitored.

In operation, vessels 112 are mounted on the support plate 80 adjacent respective recesses 90, either manually or using automated handling equipment, and the plates 92 are actuated to clamp the vessels into the respective recesses 90. Samples may be mixed in each vessel 112 of the apparatus 10 by introducing sample components, for example liquids or liquids and solids, either manually or using any convenient automated dispensing equipment, into the vessels 112 through the open tops thereof. If required, caps (not shown) may be used to seal the open tops of the vessels 112. The drive mechanisms for the impellers 120 are then operated to rotate them at high speed, typically in the range 500 rpm to 4000 rpm, to mix the components to form the samples in the respective vessels 112 similarly as described with respect to FIG. 1.

The drives to the respective impellers 120 are operated for a period sufficient to produce a substantially homogeneous mixture of the components to form the samples, which may be simple mixing of the components or it may also involve physical or chemical reactions.

The samples from individual vessels may then be dispensed substantially as described with reference to FIG. 2. It will be appreciated it is within the scope of the present invention that, following retraction of the plates 92, the removal of the caps, if present, and the presentation of the vessels 112 to a dispensing station and engagement with respective piston members 40 may be either performed manually or using automated handling equipment.

1. An apparatus for mixing small samples of materials comprising a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel.

2. The apparatus according to claim 1 wherein the vessel has an overall capacity of not more than about 100 ml, more preferably not more than about 20 ml.

3-9. (canceled)

10. The apparatus according to claim 1, wherein the agitator means comprises a helical member mounted within the vessel.

11. The apparatus according to claim 10 wherein the helical member comprises a substantially cylindrical helical spring.

12. The apparatus according to claim 10 wherein the helical member is mounted on the impeller for rotation therewith.

13-15. (canceled)

16. The apparatus according to claim 1, comprising an array of said vessels.

17. An apparatus for mixing and dispensing small samples of materials comprising a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, said material removal means comprising a piston member adapted to fit in sealed relationship with the peripheral wall of said vessel, said piston member having an axially-extending through passage which, in use, communicates at one end with the interior of said vessel and forms a dispense opening at the other end whereby axial movement of said piston member within said vessel to apply pressure to a sample formed therein will cause said sample to flow through said passage.

18. The apparatus according to claim 17 wherein the vessel has an overall capacity of not more than about 100 ml, more preferably not more than about 20 ml.

19-25. (canceled)

26. The apparatus according to claim 17, wherein the agitator means comprises a helical member mounted within the vessel.

27. The apparatus according to claim 26 wherein the helical member comprises a substantially cylindrical helical spring.

28. The apparatus according to claim 26 wherein the helical member is mounted on the impeller for rotation therewith.

29-32. (canceled)

33. The apparatus according to claim 17 comprising an array of said vessels.

34. A method of mixing small samples of materials comprising providing a vessel for containing sample components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, introducing at least two components into said vessel, operating said impeller and agitator means for a period sufficient to effect mixing of said components into a substantially homogeneous sample.

35. A method of mixing and dispensing small samples of materials comprising providing a vessel for containing components to be mixed, said vessel having a base, a peripheral wall extending from the base to the top of said vessel and an open top through which sample components may be introduced into said vessel, an impeller located in said vessel at or adjacent the base, a shaft extending through the base in sealed rotational relationship therewith, said shaft extending generally coaxially of said vessel and being engaged in driving relationship with said impeller, and agitator means located in said vessel for imparting shear forces to sample components within said vessel, said agitator means either being movable axially of said vessel towards the bottom of said vessel or being of complementary fit to material removal means whereby during use said agitator means does not interfere substantially with removal of material from said vessel, introducing at least two components into said vessel, operating said impeller and agitator means for a period sufficient to effect mixing of said components into a substantially homogeneous sample, placing said material removal means comprising a piston member adapted to fit in sealed relationship with the peripheral wall of said vessel into the top of said vessel, said piston member having an axially-extending through passage communicating at one end with the interior of said vessel and forming a dispense opening at the other end, moving said piston member axially within said vessel to apply pressure to said sample to cause said sample to flow through said passage, said piston member also engaging said agitator means to apply force to it and to move it axially towards the bottom of said vessel.

36. The method according to claim 34 wherein the agitator means comprises a helical member mounted within the vessel.

37. (canceled)

38. The method according to claim 34 wherein the sample capacity of the vessel is not more than about 50 ml, more preferably not more than about 25 ml and is preferably in the range 5 ml to 15 ml.

39. The method according to claim 34 comprising providing an array of said vessels and, in parallel or serially, introducing said at least two components into each said vessel.

40-47. (canceled)

48. The method according to claim 35 wherein the agitator means comprises a helical member mounted within the vessel.

49. The method according to claim 35 wherein the sample capacity of the vessel is not more than about 50 ml, more preferably not more than about 25 ml and is preferably in the range 5 ml to 15 ml.

50. The method according to claim 35 comprising providing an array of said vessels and, in parallel or serially, introducing said at least two components into each said vessel.
